(19) United States
(12) Patent Application Publication
(10) Pub. No.: US 2026/0254395 A1
(43) Pub. Date: Aug. 27, 2026

(54) MOTOR VEHICLE WITH AN ELECTRIC MACHINE

(71) Applicant: MAGNA Powertrain GmbH & Co KG, Lannach (AT)

(72) Inventors: Markus Gebert, Bretzfeld (DE); Thorsten Stepper, Waldenburg (DE)

(21) Appl. No.: 19/546,505

(22) Filed: Feb. 23, 2026

(30) Foreign Application Priority Data
Feb. 26, 2025 (DE) 10 2025 107 347.3

(51) Int. Cl. H02P 29/66; H02K 7/00; H02K 11/215

(52) U.S. Cl. CPC H02P 29/662; H02K 7/006; H02K 11/215

(57) ABSTRACT

A motor vehicle includes an electric machine having a stator and a rotor, which is rotatable relative to the stator, and a rotor shaft is driven by the rotor of the electric machine. The motor vehicle includes a TMR sensor in the form of a magnetic position sensor for determining the position of the rotor shaft. A magnet is non-rotatably mounted on the rotor shaft, and the TMR sensor is configured to provide at least one voltage value for determining the position of the rotor shaft depending on the orientation of a magnetic field of the magnet mounted non-rotatably on the rotor shaft. A control unit of the motor vehicle is configured to determine the temperature at the TMR sensor from the voltage value of the TMR sensor.

### CROSS-REFERENCE TO RELATED APPLICATIONS

This application claims the benefit of German Patent Application No. DE 10 2025 107 347.3, filed Feb. 26, 2025, the entire content of which is incorporated by reference in its entirety.

### FIELD

The present disclosure relates to a motor vehicle with an electric machine comprising a stator and a rotor, which is rotatable relative to the stator, wherein a rotor shaft is driven by the rotor of the electric machine.

### BACKGROUND

It is well known that at the present time motor vehicles use electric motors, particularly as drive motors in order to provide a drive torque for operating the motor vehicle. Knowing the temperature at the electric machine is advantageous for controlling the electric machine. For safe and convenient operation, and to avoid overloading components, one or more temperature sensors, for example NTCs, are often used in electric machines and their associated vehicle transmissions. These then measure, e.g., the temperature at the stator and the stator winding, respectively, or the oil sump temperature. For diagnostic reasons, it may even be necessary to use a second measurement value to check the plausibility of the sensor readings.

For cost reasons and to keep failure rates low, attempts are made to use as few temperature sensors as possible, or ideally none, or to integrate them into components that already have a circuit board and wiring such as an oil temperature sensor on an oil-pump circuit board.

It is also known, e.g., from CN 108847799 A, how to calculate the stator winding temperature based on the electrical resistance.

However, measuring the stator resistance and calculating the temperature from operation of the electric machine is computationally intensive and may require an additional voltage measurement of the phases. Each temperature sensor and its requisite wiring, as well as the circuitry and power supply from the inverter, cost money.

Additionally, the failure rate of the overall system increases, in particular, because the wiring inside the electric machine can also be prone to error. Diagnostic procedures for each sensor must also be implemented as software.

A determination of the temperature on the electric machine without having to use a separate temperature sensor and without complicated, complex temperature, and diagnostic calculations would therefore be advantageous.

### SUMMARY

It is an object of the present disclosure to provide a motor vehicle with an electric machine, wherein a temperature determination of the temperature at the electric machine can be made in a cost-effective, simple, and reliable manner.

The object is achieved by a motor vehicle having an electric machine comprising a stator and a rotor, which is rotatable relative to the stator, wherein a rotor shaft is driven by the rotor of the electric machine, wherein the motor vehicle comprises a tunnel magnetoresistance (TMR) sensor as a magnetic position sensor for determining the position of the rotor shaft, wherein a magnet is non-rotatably mounted on the rotor shaft, wherein the TMR sensor is configured so that, depending on the orientation of a magnetic field of the magnet non-rotatably mounted on the rotor shaft, it supplies at least one voltage value for determining the position of the rotor shaft, wherein a control unit of the motor vehicle is configured to determine the temperature at the TMR sensor based on the voltage value of the TMR sensor. According to the present disclosure, a TMR sensor is used for determining the position, i.e., determining the angular position of a rotor shaft of an electric machine, and the same TMR sensor is also used for determining the temperature.

The temperature dependence of the output signal of a magnetic position sensor, i.e., the TMR sensor, is used to calculate or measure the temperature at the TMR sensor, and thus at the electric machine.

A separate temperature sensor and the associated costs can thus be eliminated. The diagnostic effort for such sensors is reduced. Diagnostics for the use of the TMR sensor as a position sensor, e.g., for detection of line breaks, is usually already implemented. Additional components on the inverter are also not required. The calculations needed to determine a temperature at the electric machine based on the TMR sensor output signal are simple and straightforward. Complicated calculations in the inverter can therefore also be omitted.

Further developments of the present disclosure are specified throughout the claims, the description and the accompanying drawings.

Preferably, the temperature is determined from the amplitude of the voltage value or from a value dependent on the amplitude of the voltage value, in particular from the single or double amplitude, i.e., the peak-to-peak voltage, or from the square of the single or double amplitude.

Preferably, the TMR sensor is configured to provide two voltage values for determining the position of the rotor shaft, depending on the orientation of a magnetic field of the magnet, which is mounted in non-rotatably on the rotor shaft, wherein the control unit of the motor vehicle is configured to determine the temperature at the TMR sensor based on the two voltage values of the TMR sensor. Particularly preferably, the two voltage values of the TMR sensor represent a sine and cosine value of the voltage.

Preferably, the temperature is calculated from the voltage value of the TMR sensor or determined from a lookup table and/or a characteristic curve. The determined, in particular calculated, temperature can initially refer to the TMR sensor and, depending thereon, a temperature at another position of the electrical machine can be determined, or a temperature at another position of the electrical machine can be directly inferred from the voltage value(s).

The temperature can preferably be determined by applying a linear relationship between the TMR sensor temperature and voltage value.

Preferably, in determining the temperature from the voltage value of the TMR sensor, the level of the supply voltage of the TMR sensor is taken into account.

Preferably, the voltage value for determining the temperature is evaluated over at least one, preferably over several revolutions of the rotor shaft, in order to obtain more accurate results.

Initially, the TMR sensor can be trained at a known temperature as a reference temperature, before the temperature at the TMR sensor is determined from the voltage value of the TMR sensor during further operation. Alternatively, a temperature determination can also be made without a training process, for example using information from the sensor data sheet.

### BRIEF DESCRIPTION OF THE DRAWINGS

The present disclosure is described below by way of example with reference to the drawings.

FIG. 1 is a schematic representation of the output signals of a TMR sensor in a motor vehicle according to the present disclosure.

FIG. 2 represents a formula for calculating the amplitude as a voltage value for calculating the temperature in a motor vehicle according to the present disclosure.

FIG. 3 is a schematic representation of the amplitudes from the output signals of a TMR sensor in a motor vehicle according to the present disclosure at different temperatures.

FIG. 4 is a schematic representation of a signal flow in a motor vehicle according to the present disclosure.

### DETAILED DESCRIPTION

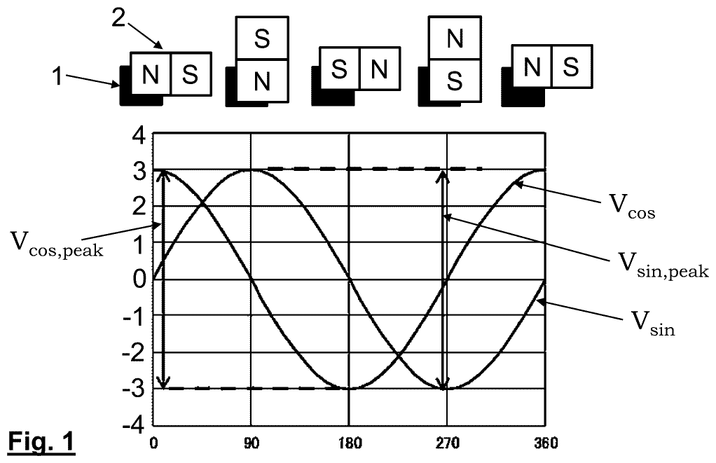

FIG. 1 schematically depicts output signals V_{cos}, Vₛᵢₙ of a TMR sensor 1 in a motor vehicle according to the present disclosure. The angle in degrees is shown on the x-axis and the voltage in volts is shown on the y-axis.

A magnetic position sensor, i.e., the TMR sensor 1, provides two differential voltages V_{cos}, Vₛᵢₙ, depending on the orientation of the magnetic field 2 of a magnet mounted on a rotor shaft. Viewed over the working range (for example over 360° or 180°), these represent a sine or cosine with a maximum or minimum voltage. The difference between these two voltages is referred to as peak-peak voltage V_{cos,peak}, V_{sin,peak} and represents twice the amplitude A.

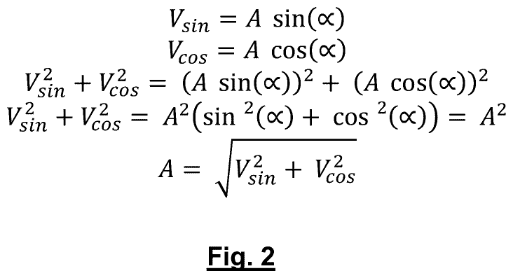

This voltage, V_{cos}, Vₛᵢₙ, depends on the supply voltage of the sensor, but also on the temperature T at the TMR sensor 1 and thus at the electric machine. Depending on the sensor 1 used, the relationship with the temperature T is usually approximately linear or can be described mathematically in other ways. The sensor voltage V_{cos}, Vₛᵢₙ is stable and known and can therefore also very well be taken into account in the evaluation. The peak-peak voltage V_{cos,peak}, V_{sin,peak}, or half of it, can be determined using various methods. One possibility is to use the mathematical relationship as shown in the formula in FIG. 2. However, other methods may also be used within the scope of the present disclosure.

The following can thus be used to calculate the amplitude A:

$${V}_{sin} = A sin ( ∝ )$$

$${V}_{cos} = A cos ( ∝ )$$

$${V}_{sin}^{2} + {V}_{cos}^{2} = {( A sin ( ∝ ) )}^{2} + {( A cos ( ∝ ) )}^{2}$$

$${V}_{sin}^{2} + {V}_{cos}^{2} = {A}^{2} ( {sin}^{2} ( ∝ ) + {cos}^{2} ( ∝ ) ) = {A}^{2}$$

$$A = \sqrt{{V}_{sin}^{2} + {V}_{cos}^{2}}$$

### Where:

Vₛᵢₙ: Sensor sine signal
V cos: Sensor cosine signal
A: Sensor amplitude or half peak-to-peak value (V_{cos,peak}, V_{sin,peak})
∝ (Alpha): Rotor position (angle)

The temperature T can now be calculated from this amplitude A. Filtering over one or more revolutions of the rotor shaft of the electric machine may increase the accuracy of the calculation.

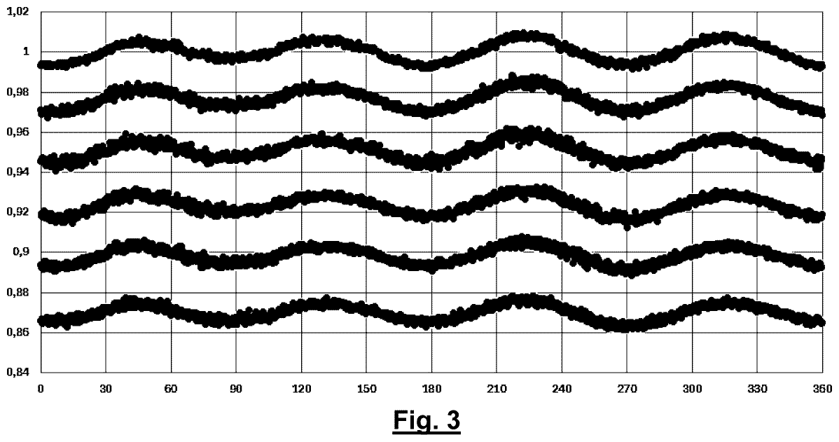

FIG. 3 schematically shows different amplitudes A, which are determined from the output signals V_{cos}, Vₛᵢₙ of a TMR sensor 1 in a motor vehicle according to the present disclosure with a 48V electric machine at different temperatures T, during a complete rotation of the rotor shaft by 360 degrees.

The top curve whose amplitude A was set to a value of 1 corresponds to a temperature of −20 degrees Celsius. Downwards, the temperatures T on TMR sensor 1 rise to 0, 20, 40, 60 and 80 degrees Celsius. As can be seen, the relationship between amplitude A and temperature T is approximately linear.

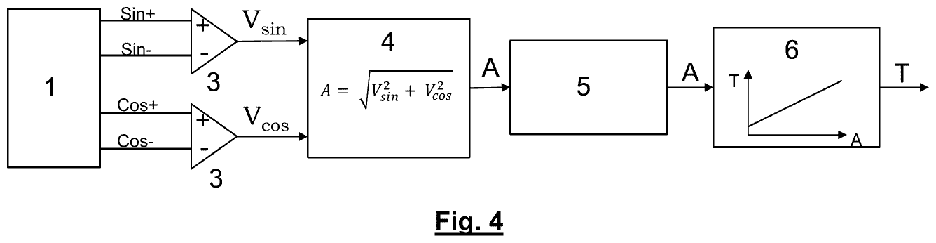

Finally, FIG. 4 schematically shows the determination of the temperature T by a control unit in a motor vehicle.

The TMR sensor 1 initially supplies analog positive and negative sine and cosine voltages Sin+, Sin−, Cos+, Cos− as outputs. These analog outputs are converted by an AD converter 3 to the digital voltage values Vₛᵢₙ and V_{cos}.

The next step is an amplitude calculation 4, in which, for example, using the formula

$$A = \sqrt{{V}_{sin}^{2} + {V}_{cos}^{2}} ,$$

an amplitude A is calculated.

In a next step, the filtering and/or plausibility check 5, the amplitude value A can be checked for plausibility and preferably filtering of the value A takes place, e.g., by taking into account several revolutions of the rotor shaft. Finally, in a concluding step, the actual temperature calculation 6 takes place, for example by using a linear relationship between the amplitude A and the temperature T.

Within the scope of the present disclosure, for example, the type and manner of the peak-peak voltage or the amplitude determination A of the output signal of the TMR sensor 1 is carried out in different ways.

Also, for example, only one of the two sensor signals (sine or cosine, Vₛᵢₙ or V_{cos}) or only the positive or negative output of the TMR sensor 1, relative to another potential for temperature measurement, can be used to calculate the temperature T.

The required formulas can be partially or completely stored as characteristic curves and used for temperature calculation. The temperature dependence can also be directly represented as a formula or table of the square of the amplitude, i.e., A², so that no square root function is needed and the resource consumption on the control unit is reduced.

Without standardizing the amplitude A to 1 at a certain temperature, a reference temperature for training sensor 1 as a temperature sensor can be omitted and, for example, the information from its data sheet can be used.

### REFERENCE NUMERAL LIST

1 TMR sensor
2 Magnetic field
3 AD converter
4 Amplitude calculation
5 Filtering and/or plausibility check
6 Temperature calculation
A Amplitude
Cos+ analog, positive voltage cosine
Cos− analog negative voltage cosine
Sin+ analog, positive voltage sine
Sin− analog negative voltage sine
T Temperature
V_{cos} Voltage value (cosine)
Vₛᵢₙ Voltage value (sine)
V_{cos,peak} Peak-to-peak voltage (cosine)
V_{sin,peak} Peak-to-peak voltage (sine)

What is claimed is:

1. A motor vehicle having an electric machine comprising a stator and a rotor, which is rotatable relative to the stator, wherein a rotor shaft is driven by the rotor of the electric machine, the motor vehicle comprising:
a TMR sensor in the form of a magnetic position sensor that determines a position of the rotor shaft,
wherein a magnet is non-rotatably mounted on the rotor shaft,
wherein the TMR sensor provides at least one voltage value for determining the position of the rotor shaft depending on the orientation of a magnetic field of the magnet mounted non-rotatably on the rotor shaft,
wherein a control unit of the motor vehicle determines a temperature at the TMR sensor based on the voltage value of the TMR sensor.

2. The motor vehicle of claim 1,
wherein the temperature is determined from an amplitude of the voltage value.

3. The motor vehicle according to claim 1,
wherein the TMR sensor provides two voltage values for determining the position of the rotor shaft, depending on the orientation of the magnetic field of the magnet mounted non-rotatably on the rotor shaft, wherein the control unit of the motor vehicle determines the temperature at the TMR sensor from the two voltage values of the TMR sensor.

4. The motor vehicle according to claim 1,
wherein the temperature is calculated from the voltage value of the TMR sensor or is determined from a lookup table and/or from a characteristic curve.

5. The motor vehicle according to claim 1,
wherein the temperature is determined by a linear relationship with the voltage value of the TMR sensor.

6. The motor vehicle according to claim 1,
wherein a level of the supply voltage of the TMR sensor is taken into account when determining the temperature based on the voltage value of the TMR sensor.

7. The motor vehicle according to claim 1,
wherein the voltage value for determining the temperature is evaluated over at least one revolution of the rotor shaft.

8. The motor vehicle according to claim 1,
wherein the TMR sensor is first trained at a known temperature as a reference temperature, before the temperature is determined at the TMR sensor based on the voltage value of the TMR sensor during further operation.

9. The motor vehicle according to claim 1,
wherein the temperature is determined from a value dependent on the amplitude of the voltage value.

10. The motor vehicle according to claim 1,
wherein the temperature is determined from a single or double amplitude.

11. The motor vehicle according to claim 10,
wherein the temperature is determined from a peak-to-peak voltage.

12. The motor vehicle according to claim 10,
wherein the temperature is determined from a square of the single or double amplitude.

13. The motor vehicle according to claim 3,
wherein the two voltage values of the TMR sensor correspond to a sine value and a cosine value of the voltage.

14. The motor vehicle according to claim 1,
wherein the voltage value for determining the temperature is evaluated over several revolutions of the rotor shaft.

15. A method of determining a temperature of an electric machine of a motor vehicle, the electric machine having a rotor and a stator, and a rotor shaft that rotates relative to the stator, the method comprising:
driving the rotor shaft relative to the stator;
determining a position of the rotor shaft from a TMR sensor, wherein the TMR sensor is in the form of a magnetic position sensor, wherein a magnetic is non-rotatably mounted on the rotor shaft;
receiving at least one voltage value from the TMR sensor at a control unit of the motor vehicle;
based on the at least one voltage value, determining, by the control unit, a temperature at the TMR sensor.

16. The method according to claim 15,
wherein the at least one voltage value is in the form of sine voltage and a cosine voltage.

17. The method according to claim 16,
wherein the temperature is determined based on an amplitude value determined from the sine voltage and the cosine voltage.
